(19) United States
(12) Patent Application Publication
(10) Pub. No.: US 2025/0026499 A1
(43) Pub. Date: Jan. 23, 2025

(54) VISION-BASED AUTONOMOUS NAVIGATION SYSTEM AND METHOD FOR A SATELLITE

(71) Applicant: INFINITE ORBITS, Gardanne (FR)

(72) Inventors: Emmanuel KOUMANDAKIS, Toulouse (FR); Marco NEDUNGADI, Singapour (SG); Akshay GULATI, Singapour (SG); Massimo PIAZZA, Toulouse (FR); Adrian AGUINAGA, Toulouse (FR)

(73) Assignee: INFINITE ORBITS, Gardanne (FR)

(21) Appl. No.: 18/713,778

(22) PCT Filed: Nov. 22, 2022
(86) PCT No.: PCT/EP2022/082716

§ 371 Date: May 28, 2024

(30) Foreign Application Priority Data
Nov. 26, 2021 (FR) FR2112597

(51) Int. Cl. B64G 1/24; B64G 1/36; B64G 1/68; G06T 7/277; G06T 7/70; G06V 10/762; G06V 10/82

(52) U.S. Cl. CPC B64G 1/247; B64G 1/242; B64G 1/369; B64G 1/68; G06T 7/277; G06T 7/70; G06V 10/762; G06V 10/82; G06T 2207/10032; G06T 2207/20024; G06T 2207/20084

(57) ABSTRACT

The invention relates to a system and method for autonomous navigation of a host satellite equipped with moving and orienting means, a unit for controlling these means, and at least one on-board image-acquisition camera, said method comprising the following steps: acquiring (E1) a plurality of images; default processing of said images, referred to as long-range processing (E2), configured to detect and identify space objects and to calculate their relative orbits; conditional processing of said acquired images, referred to as short-range processing (E3), configured to estimate the attitude of at least one of said space objects, referred to as target object, detected during the long-range processing, this step being implemented when said long-range step detects at least one space object located at a distance estimated to be less than a predetermined threshold distance; determining (E4) a possible rendezvous between at least said target object and the host satellite; preparing and transmitting instructions (E5) to said control unit of said moving means based on at least one rendezvous and/or risk of collision determined in the previous step.

### TECHNICAL FIELD OF THE INVENTION

The invention relates to the autonomous navigation of satellites. The invention relates more particularly to an autonomous navigation system and method for a satellite equipped with at least one image-acquisition camera.

### TECHNOLOGICAL BACKGROUND

It is estimated that there are currently more than 2 700 operational satellites in orbit around the Earth and more than 900 000 items of space debris measuring more than 1 cm. All of these space objects (satellites and debris) move at very high speeds (approximately 3 000 m/s in geostationary orbit).

Throughout the text, the term “space debris” is used to mean an artificial, non-functional object in orbit. It can be a bolt, a paint chip, a launcher stage, a “dead” satellite, residue from an explosion of a spacecraft, etc.

Throughout the text, the term “target” or “space object” is used to mean any object in orbit such as space debris or a functional satellite. In other words, the concept of target or space object covers operational satellites as well as space debris.

Throughout the text, the term “celestial object” is used to mean any non-artificial object such as a star, a comet, a galaxy possibly present in an acquired image.

Throughout the text, the term “object”, when not more precisely specified, refers either to a “celestial object” or to a “space object”.

The large number of these space objects present in orbit as well as their rapid increase make it necessary to have solutions allowing reactive control of operational satellites to avoid in particular collisions with these space objects.

Similarly, the diversification and massification of orbiting satellites produces a market for orbiting services, particularly for extending the lifespan for commercially operational satellites at the end of their life cycle.

Therefore, a navigation system ensuring the movement of the service satellite towards possible rendezvous points as well as the maintenance of the host satellite in position now proves necessary.

Up to now, the majority of satellites are controlled from ground stations by human operators. However, the cluttered environment mentioned above currently makes human intervention less compatible with the requirement of a very high level of reactivity needed to maintain the integrity of the satellites.

There is thus a need to have a totally autonomous solution allowing navigation of satellites in orbit without human intervention.

There are already attempts to propose semi-autonomous navigation solutions using several complex sensors such as LiDAR, but the human presence often remains necessary, for example to validate the navigation trajectories determined from data from different sensors. Furthermore, these solutions using LiDAR are bulky, large and consume a lot of energy and so the corresponding costs are high.

The inventors have thus sought to propose a new solution for automatic control of satellites from images provided by monocular, monochromatic or polychromatic cameras.

### AIMS OF THE INVENTION

The invention aims to provide an autonomous navigation system and method for satellites.

The invention aims in particular to provide such a system and method which allow autonomous navigation of a satellite from a batch of images, e.g. monochromatic images, acquired by at least one camera on-board the satellite.

The invention also aims to provide, in at least one embodiment, such a system and method which contribute to moving the satellite to a predetermined rendezvous point or to a non-cooperative target space object.

The invention also aims to provide, in at least one embodiment, such a system and method which allow inspection of the area surrounding the satellite.

The invention also aims to provide, in at least one embodiment, such a system and method which allow determination of the attitude of the satellite.

The invention also aims to provide, in at least one embodiment, such a system and method which allow inspection and tracking of a target object.

The invention also aims to provide, in at least one embodiment, such a system and method which allow pose determination (attitude and relative position) of a target object.

The invention also aims to provide, in at least one embodiment, such a system and method which allow detection of space debris and avoidance of collisions with the surrounding space objects.

The invention also aims to provide, in at least one embodiment, such a system and method which do not require the fitting of complex sensors such as LiDAR, radar and equivalent equipment.

The invention also aims to provide, in at least one embodiment, such a system and method which limit the size and weight of the equipment necessary for the implementation thereof.

The invention also aims to provide, in at least one embodiment, such a system and method which limit the energy necessary for the implementation thereof.

Finally, the invention is directed to a satellite equipped with a system in accordance with the invention and implementing a method in accordance with the invention.

### DESCRIPTION OF THE INVENTION

For this purpose, the invention relates to a method for autonomous navigation of a satellite, referred to as host satellite, equipped with means for moving and orienting said satellite, a unit for controlling these means, and at least one on-board camera for acquiring images of the area surrounding said satellite.

The method in accordance with the invention is characterized in that it comprises the following steps:
a step of acquiring a plurality of images by said on-board camera,
a step of default processing of said acquired images, referred to as long-range processing, configured to detect and to identify space objects within said images, to calculate their relative orbits and distances with respect to the host satellite, and to determine the attitude of the host satellite,
a step of conditional processing of said acquired images, referred to as short-range processing, configured to estimate the pose of at least one of said space objects, referred to as target object, detected and identified during the long-range processing, said short-range step being implemented when said long-range step detects at least one space object located at a distance estimated to be less than a predetermined threshold distance,
a step of determining a possible rendezvous between at least said target object and the host satellite from an estimation of the trajectory of said target object and of said host satellite,
a step of preparing and transmitting command instructions to said control unit of said means for moving and orienting said satellite based on at least one rendezvous determined in the previous step.

The method in accordance with the invention thus allows totally autonomous navigation of the satellite without human intervention from images of the area surrounding the satellite acquired by an on-board camera. All of the steps of acquiring the images, processing the images, calculating and determining the trajectories and flight parameters are effected on-board the host satellite without external intervention.

The method in accordance with the invention makes it possible to provide the host satellite with situational awareness in space, i.e. it can obtain information regarding the area surrounding it and adapt its trajectory and/or orientation based on this information. This information comes exclusively from the images acquired by at least one camera on-board the satellite. The method in accordance with the invention uses no sensor other than image-acquisition cameras to ensure the autonomous navigation of the satellite.

The method in accordance with the invention implements two separate image processing steps depending upon the distance of the identified target objects, which permits precise navigation of the satellite based on the identified objects. In proximity to a target object (in practice the threshold distance is set at 250 meters for the typical dimensions of geostationary satellites—of the order of 2 meters in diameter), the method switches from a long-range processing mode to short-range processing which allows estimation of the position, orientation and speed of the target object so as to maneuver the satellite accordingly (approach or avoid).

Advantageously and in accordance with the invention, said long-range processing step further comprises:
thresholding the images,
clustering different points of the thresholded images,
calculating the centers of the different clusters of the image,
classifying and filtering the different clusters forming said detected celestial and space objects.

According to this advantageous variant, the initial detection of the celestial and/or space objects consists of recognizing clusters within the acquired images and classifying and filtering them in order to remove, in particular, flares and hot spots. These steps are implemented for example by a data clustering algorithm such as that known as DBSCAN (“Density-based spatial clustering of applications with noise”).

Advantageously and in accordance with the invention, said long-range processing step further comprises:
comparing said detected celestial and space objects with a predetermined catalogue of celestial objects so as to identify at least one celestial object from among the detected objects,
determining the attitude of said host satellite from a position of at least one of the identified celestial objects.

According to this advantageous variant, determining the attitude of the host satellite is based on the detection and recognition of celestial objects within the acquired images. This is made possible by identifying stars within the images by comparing the detected objects with a reference catalogue, for example the Hipparcos-2 catalogue. The angles between the identified potential stars are analyzed in order to recognize a configuration similar to a configuration in the above-mentioned catalogue. This angle-based technique makes it possible to determine that some celestial object identified within the image corresponds to some celestial object in the reference catalogue.

Once the stars are identified, the attitude can be estimated.

Advantageously and in accordance with the invention, said attitude-determining step comprises implementing an extended Kalman filter (EKF) from a first estimation of the angular speed and attitude of the host satellite and the position of at least one identified celestial object (preferably three identified celestial objects).

In other words, according to this variant, determining the attitude of the host satellite consists of using an extended Kalman filter into which the position of at least one star (preferably three stars) and a first estimation of the angular speed of the host satellite are input, and which outputs an estimation of the attitude of the host satellite.

This first estimation of the angular speed can be, for example, obtained by successively implementing (at least twice) a scenario known as “Lost in Space” which consists of comparing the entirety of a catalogue of stars with the stars detected in the acquired images. The variation in position of the host satellite between the two scenarios can thus be determined, which makes it possible to derive a first estimation of the angular speed of the host satellite.

Advantageously and in accordance with the invention, said long-range processing step comprises:
calculating the position of at least one detected and identified space object within the image, referred to as target object,
calculating orbital features of said target object from the determination of the attitude of the host satellite and the position of said calculated target object.

According to this advantageous variant, calculating the relative orbit of each target object consists of using navigation filters based on the angles of the target object. During the long-range processing, since the target is located at a distance greater than the predetermined threshold distance and thus too far from the camera to perceive the angles of the target object, the angles found within the field of vision of the camera are used to determine the relative navigation of the host satellite.

Advantageously and in accordance with the invention, said short-range processing step comprises:
detecting a zone of interest comprising the target object of interest by executing a first neural network,
regressively detecting landmarks in said detected zone of interest by executing a second neural network,
estimating the pose of the target object from the landmarks detected in the previous step.

According to this advantageous variant, the short-range processing step begins by separating the target object of interest (target satellite, debris, etc.) from its background. This is effected by a deep learning neural network model. It can, for example, implement the algorithm known as YOLO (“You Only Look Once”) which makes it possible to detect objects by dividing the image into a grid system, each cell thereof being processed for detecting an object. The first step thus makes it possible to recognize the region of interest and to provide a first estimation of the position of the target object. A second step makes it possible to detect points of interest of the target object. This is achieved by a second neural network trained to regressively detect landmarks (also referred to herein as LRN (“Landmark Regressive Network”)). This sub-step can, for example, implement the architecture known as HRNet (“High Resolution Network”).

Finally, a third step makes it possible to estimate the pose of the target object from the points of interest discovered in the previous step and by searching for the best possible pose estimation from, for example, a priori knowledge of the 3D architecture of the target. This can be obtained by implementing the algorithm known as EPnP (“Efficient Perspective-n-Point”).

According to another variant, it is possible to determine the 3D architecture of the target object by photogrammetry techniques, which makes it possible to dispense with a priori knowledge of the 3D architecture of the target object.

The short-range processing is effected only if a target object detected and identified during the long-range processing step is located at a distance from the target satellite which is less than a predetermined threshold distance. This short-range processing step aims to determine the pose of the target object so as to be able to determine the navigation settings for the host satellite.

Advantageously and in accordance with the invention, said step of determining a possible rendezvous comprises:
estimating the trajectory of the host satellite from a linearized model of the satellite's dynamics,
calculating the probability of collision with an identified space object.

According to this variant, estimating the trajectory is based on a linearized model of the host satellite's dynamics from, for example, Clohessy-Wiltshire equations. Calculating the probability of collision can also be effected in the case of debris in order to estimate a probability of collision between the host satellite and the debris.

Advantageously and in accordance with the invention, said step of preparing and transmitting command instructions to said control unit comprises:
dynamically simulating the flight of said host satellite,
modelling the commands from said dynamic simulation,
repeating the previous steps until said target object is reached or avoided.

According to this advantageous variant, the last step of the method consists of preparing the control commands for the satellite to avoid the collision in the case of debris or, in contrast, to ensure the rendezvous in the case of a satellite to be met with. This step is based on the trajectories determined in the previous step and implements a dynamic simulation of the flight of the host satellite and a command model. In the case of a desired rendezvous, the commands are optimized to minimize different parameters such as the distance to be covered, the consumption of propellant or the number of maneuvers. This optimization can depend on constraints inherent in the target objects or the status of the host satellite (propellant reserve, battery status, enhanced security, etc.).

According to a variant of the invention, this step of determining and transmitting commands aims to respond to the three following objectives: avoiding a target object (avoiding maneuver), approaching the target object (rendezvous maneuver) or keeping the satellite in the current configuration (no specific maneuver).

The invention also relates to a system for autonomous navigation of a satellite, referred to as host satellite, equipped with means for moving and orienting said satellite, a unit for controlling these means, said system being characterized in that it comprises:
at least one camera for acquiring a plurality of images of the area surrounding said host satellite,
a module for default processing of said acquired images, referred to as long-range module, configured to detect and to identify space objects within said images, to calculate their relative orbits and distances with respect to the host satellite, and to determine the attitude of said host satellite,
a module for conditional processing of said acquired images, referred to as short-range module, configured to estimate the attitude of at least one of said space objects, referred to as target object, detected and identified by said long-range module, said short-range module being implemented when said long-range module has detected at least one space object located at a distance estimated to be less than a predetermined threshold distance,
a module for determining a possible rendezvous between at least said target object and the host satellite from an estimation of the trajectory of said target object and of said host satellite,
a module for preparing and transmitting command instructions to said control unit of said means for moving and orienting said satellite based on said rendezvous determined by said rendezvous-determining module.

The autonomous navigation system in accordance with the invention advantageously implements the autonomous navigation method in accordance with the invention and the autonomous navigation method in accordance with the invention is advantageously implemented by a system in accordance with the invention.

The technical effects and advantages of the method in accordance with the invention apply mutatis mutandis to the system in accordance with the invention.

Throughout the text, the term “module” means a software element, a subset of a software program, which can be compiled separately, either for independent use or to be combined with other modules of a program, or a hardware element, or a combination of a hardware element and a software subroutine. Such a hardware element can comprise an application-specific integrated circuit (ASIC) or a field-programmable gate array (FPGA) or a digital signal processor (DSP) or any equivalent hardware or any combination of said types of hardware. Generally, a module is thus an element (software and/or hardware) which makes it possible for a function to be performed.

In the present case, the modules of the system in accordance with the invention are preferably implemented by software means, i.e. by a sequence of instructions of a computer program, this sequence of instructions being able to be stored on any type of medium which can be partially or totally read by a computer or by a microprocessor on-board the satellite.

Advantageously and in accordance with the invention, the system comprises an image-acquisition camera intended to provide images to the long-range processing module and an image-acquisition camera intended to provide images to the short-range processing module.

According to this advantageous variant, the system comprises two separate cameras respectively intended to provide images to the long-range processing module and to the short-range processing module. This variant makes it possible to benefit from a specific camera suitable for the corresponding processing.

The invention also relates to a method and system for autonomous navigation of a satellite which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic view of the main steps of the navigation method in accordance with the invention,

FIG. 2 is a schematic view of the autonomous navigation system in accordance with one embodiment of the invention,

FIG. 3 is a schematic block diagram of the steps for long-range processing of the images in accordance with one embodiment of the invention,

FIG. 4 is a schematic block diagram of the steps for short-range processing of the images in accordance with one embodiment of the invention.

### DETAILED DESCRIPTION OF AN EMBODIMENT OF THE INVENTION

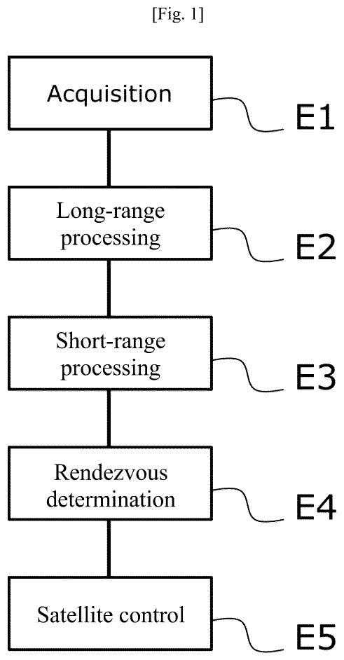

FIG. 1 schematically illustrates the main steps of the navigation method in accordance with the invention.

The first step E1 of the navigation method in accordance with the invention consists of acquiring a plurality of images of the area surrounding the host satellite from a camera on-board the satellite. The image-capture features (exposure time, etc.) can be adapted to the operational conditions. The raw data are stored in a memory of the on-board computer to be subsequently processed during the following steps.

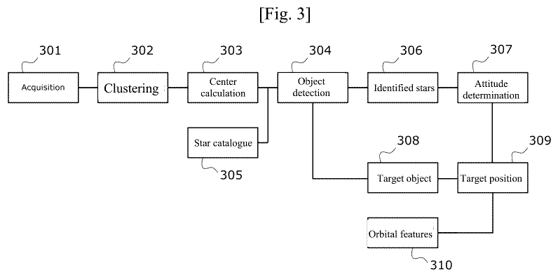

The second step E2 of the navigation method in accordance with the invention consists of performing processing, referred to as long-range processing, of the acquired images. The main function of this processing is to detect and identify space objects within said images, to calculate the relative orbits and distances of the space objects with respect to the host satellite and to determine the attitude of the host satellite. These steps will be described more precisely with reference to FIG. 3.

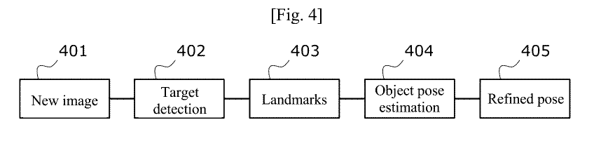

The third step E3 of the navigation method in accordance with the invention consists of performing processing, referred to as short-range processing, of the acquired images when at least one target object located within a distance less than a predetermined distance (e.g. 250 meters) has been detected in the previous step. The main function of this processing is to estimate the pose of this target object. This step will be described more precisely with reference to FIG. 4.

The fourth step E4 of the navigation method in accordance with the invention consists of determining a possible rendezvous between the target object and the host satellite from the different items of information determined during the previous steps.

The fifth and final step E5 of the navigation method in accordance with the invention consists of preparing and transmitting command instructions to the control unit which controls the means for moving and orienting the satellite. These commands depend on the rendezvous determined in the previous step.

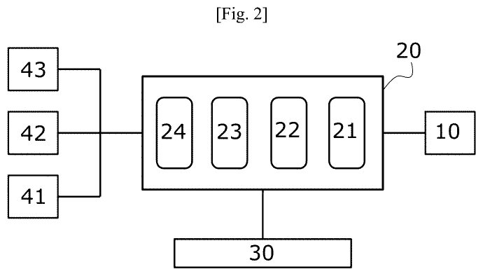

FIG. 2 is a schematic view of a navigation system in accordance with one embodiment of the invention implementing the method in accordance with the invention.

The system comprises an image-acquisition camera 10. This camera may be a monocular, monochromatic or polychromatic camera. This camera is, for example, a camera capable of acquiring three images per second. It can, for example, have a field of vision of 11° vertically and 16° horizontally. Of course, other cameras can be used without this compromising the core concept of the invention. The camera of the described embodiment makes it possible to detect target objects at a distance of 3000 km for objects having a diameter of 2 m. By way of example, a camera of 5400×3600 pixels having a focal length of 16 mm makes it possible to detect objects having a diameter of 2 m which are up to 3000 km away. Of course, other types of camera can be used depending upon the objectives sought after by the system without compromising the core concept of the invention.

The system likewise comprises an on-board computer 20 which is equipped with a microprocessor, a storage memory and which houses modules for analyzing and processing the data. This on-board computer is for example equipped with a card sold under the name Q7S Xiphos®, dedicated to space applications.

As indicated above, these modules are preferably implemented in the form of software elements loaded on the electronic card of the on-board computer.

The on-board computer 20 thus comprises a long-range processing module 21 which is configured to implement step E2 of the method in accordance with the invention and which will be described in more detail with reference to FIG. 2.

The on-board computer 20 also comprises a short-range processing module 22 which is configured to implement step E3 of the method in accordance with the invention and which will be described in more detail with reference to FIG. 3.

The on-board computer 20 also comprises a module 23 for determining a possible rendezvous between a target object and the host satellite.

Finally, the on-board computer 20 comprises a module 24 for preparing commands for a control unit which controls the means 30 for moving and orienting the host satellite.

The system in accordance with the invention can also comprise a gyroscope 41, an accelerometer 42 and a flash memory 43. The use of the gyroscope 41 makes it possible to reduce the number of variables necessary to implement the Kalman filter (EKF) since the angular speed is thus known. The flash memory 43 makes it possible to store the data and send the data to the ground when a connection is established. The gyroscope 41 and the accelerometer 42 are intended for the navigation software and can be used to improve the precision of the estimations. Nevertheless, it should be noted that these sensors are not indispensable to the implementation of the invention. Nevertheless, they make it possible to improve the precision of the measurements and/or the estimations.

FIG. 3 schematically illustrates the sub-steps implemented during the long-range processing step E2 implemented by the long-range processing module 21.

In step 301, an image acquired by the camera 10 is processed. This image is subjected to thresholding and then clustering (detection of the clusters) by a DBSCAN-type algorithm in step 302 as indicated previously so as to detect potential target space objects (also referred to as RSO (“Resident Space Object”)) followed by a calculation in step 303 of the centers of the clusters formed in step 302.

The method then comprises a step 304 of identifying the space objects present in the image. This step 304 makes it possible to detect on the one hand celestial objects present in the image by comparison with a star catalogue such as Hipparcos-2 or catalogue 305. The apparent magnitude of the celestial objects detectable during this sub-step of star tracking is at most 6 for example (of course, this value depends upon the sensor, exposure time, etc.). This step 304 makes it possible to detect on the other hand potential target objects. These potential target objects are formed by the space objects for which no match is found in the star catalogue.

Once the stars are identified in step 306, the method can determine the attitude of the host satellite in step 307. As indicated previously, this attitude determination can be made for example using an extended Kalman filter.

In step 308, if a potential target object has been detected in step 304 for detecting space objects, the method calculates the position of this target object in step 309 and calculates the orbital features of this target object from the determination of the attitude of the host satellite and of the position of the target object calculated in step 310. The details of these calculations, which are also implemented in the short-range processing step, are provided hereinafter with reference to the detailed description of the short-range processing step.

If the distance of the object is estimated to be less than the threshold distance, the short-range image processing is activated and the method switches into step E3.

FIG. 4 schematically illustrates the sub-steps implemented during the short-range processing step E3 implemented by the short-range processing module 22.

In step 401, an image acquired by the camera 10 is processed. In step 402, detection of a zone of interest is performed by implementing a first neural network trained to recognize predetermined target objects, as explained previously. To do this, the image is resized so as to have a format identical to that of the images used to train the neural network. As indicated previously, this step can implement the algorithm known as YOLO (“You Only Look Once”) which makes it possible to detect objects by dividing the image into a grid system, each cell thereof being processed for the detection of an object. The result of this first sub-step is the detection of a region of interest comprising the target object.

In step 403, the method performs regressive landmark detection in the detected zone of interest by executing a second neural network trained to perform regressive landmark detection as explained previously. To do this, the data input into this second neural network is the image of the region of interest detected in the previous step. Just like in the previous step, the image can be resized so as to have a format identical to that of the images used to train the neural network. This sub-step makes it possible to detect the points of interest of the target object present in the region of interest. This sub-step can, for example, implement the architecture known as HRNet (High Resolution Network).

In step 404, the method estimates the pose of the target object from the points of interest discovered in the previous step and by searching for the best possible pose estimation from, for example, a priori knowledge of the 3D architecture of the target. This can be obtained by implementing the algorithm known as EPnP (“Efficient Perspective-n-Point”). The aim of the algorithm is to search for which orientation and which distance will make it possible to make the discovered points of interest coincide with the a priori knowledge of the 3D architecture of the target object.

In step 404, the method can refine the determination of the pose. In particular, the EPnP method is an explicit formula, solution to a linear problem, allowing a first estimation of the pose of the target. However, even though this represents a good first estimation, it is not robust enough against the presence of aberrances in the data. This method is thus, and preferably, refined by iteratively applying a Levenbert-Marquardt method (LMM) which requires initialization with a first estimation. This is an optimization method aiming to minimize the reprojection error, i.e. to reduce to the greatest extent the distance between the points of interest and their reprojection from the known or reconstructed architecture, so as to thereby obtain a better pose estimation. This is a non-linear least squares technique using an interpolation based on the Gauss-Newton methods and the gradient descent method.

This succession of steps, which forms the short-range processing step E2, makes it possible to estimate the pose (attitude and distance) of an object from a batch of monocular images and from a priori knowledge of the 3D architecture of the target object. That being said, and as indicated previously, in accordance with another embodiment it is possible to determine the 3D architecture of the object from photogrammetry techniques, which thus makes it possible to dispense with the a priori knowledge of the 3D architecture of the target object.

Once the pose of the target object is identified, the method estimates the trajectory of the host satellite from a linearized model of the satellite's dynamics and calculation of a probability of collision with the target object (it should be noted that this step is also implemented during long-range processing as soon as a target object has been identified).

The trajectory estimation is based on a linearized model of the host satellite's dynamics from, for example, Clohessy-Wiltshire equations (in the most simple case, from a circular Kepler orbit with no perturbations). Calculating the probability of collision can also be effected in the case of debris in order to estimate a probability of collision between the host satellite and the debris.

To do this and in accordance with a preferred embodiment, the azimuth and elevation of the target are determined from optical measurements. Then, this determination is corrected using a UKF filter:
Measurement: the measurement function takes into account the non-linear nature of the angle measurement and transforms the elements into average elements,
Prediction: the transition function takes into account the relative dynamic elements of the two objects as well as other parameters such as solar pressure, the gravitational differential, etc.

The probability of collision is calculated from the relative orbital dynamic elements of the two objects as well as the covariances from a navigation filter and by applying the Chan method for analytically determining the probability density of the collision function. The filter can also be used in a decoupled manner to refine the estimation of the rotational kinematic elements of the target object.

The final step of the method consists of preparing and transmitting command instructions to the control unit which controls the means for moving and orienting the satellite (navigational computer, reaction wheels and engines). These commands depend on the rendezvous determined in the previous step. The embodiment of this step is known to a person skilled in the art and consists of controlling the control members of the satellite to achieve the sought after objective.

In accordance with the invention and owing to the calculation of the relative orbital features of the object in the previous step, this step is nothing more than solving a problem of minimizing the separation with the target. This technique is based on the eccentricity/inclination vector in the radial/normal plane and longitudinal separation in the tangential plane.

The invention is not limited to the described embodiments alone and can cover variants without departing from the intended scope of protection. In particular, according to an embodiment which is not described, the system can comprise two (or more) separate cameras respectively intended to provide images to the long-range processing module and to the short-range processing module. This variant makes it possible to benefit from a specific camera suitable for the corresponding processing.

1. A method for autonomous navigation of a satellite, referred to as host satellite, equipped with means for moving and orienting said satellite, a unit for controlling these means, and at least one on-board camera for acquiring images of the area surrounding said satellite, said method comprising:
acquiring a plurality of images by said on-board camera,
default processing of said acquired images, referred to as long-range processing, configured to detect and to identify space objects within said images, to calculate their relative orbits and distances with respect to the host satellite, and to determine the attitude of the host satellite,
conditional processing of said acquired images, referred to as short-range processing, configured to estimate the attitude of at least one of said space objects, referred to as target object, detected and identified during the long-range processing, said short-range step being implemented when said long-range step detects at least one space object located at a distance estimated to be less than a predetermined threshold distance,
determining a possible rendezvous between at least said target object and the host satellite from an estimation of the trajectory of said target object and of said host satellite, and
preparing and transmitting command instructions to said control unit of said means for moving and orienting said satellite based on at least one rendezvous determined in the previous step.

2. The navigation method as claimed in claim 1, wherein said long-range processing further comprises:
thresholding the images,
clustering different points of the thresholded images,
calculating the centers of the different clusters of the image, and
classifying and filtering the different clusters forming said detected celestial and space objects.

3. The navigation method as claimed in claim 2, wherein said long-range processing further comprises:
comparing said detected celestial and space objects with a predetermined catalogue of celestial objects so as to identify at least one celestial object from among the detected objects, and
determining the attitude of said host satellite from a position of at least one of the identified celestial objects.

4. The navigation method as claimed in claim 3, wherein said long-range processing further comprises:
calculating the position of at least one detected and identified space object within the image, referred to as target object, and
calculating orbital features of said target object from the determination of the attitude of the host satellite and the position of said calculated target object.

5. The navigation method as claimed claim 3, wherein said attitude-determining step comprises:
implementing an extended Kalman filter from a first estimation of the angular speed and attitude of the host satellite and the position of at least one identified celestial object.

6. The navigation method as claimed in claim 1, wherein said short-range processing comprises:
detecting a zone of interest comprising the target object of interest by executing a first neural network,
regressively detecting landmarks in said detected zone of interest by executing a second neural network, and
estimating the pose of the target object from the landmarks detected in the previous step.

7. The navigation method as claimed in claim 1, wherein said step determining a possible rendezvous comprises:
estimating the trajectory of the host satellite from a linearized model of the satellite's dynamics, and
calculating the probability of collision with an identified space object.

8. The navigation method as claimed in claim 1, wherein said preparing and transmitting command instructions to said control unit comprises:
dynamically simulating the flight of said host satellite,
modelling the commands from said dynamic simulation, and
repeating the previous steps until said target object is reached or avoided.

9. A system for autonomous navigation of a satellite, referred to as host satellite, equipped with means for moving and orienting said satellite, a unit for controlling these means, said system comprising:
at least one camera for acquiring a plurality of images of the area surrounding said host satellite,
a module for default processing of said acquired images, referred to as long-range module, configured to detect and to identify space objects within said images, to calculate their relative orbits and distances with respect to the host satellite, and to determine the attitude of said host satellite,
a module for conditional processing of said acquired images, referred to as short-range module, configured to estimate the attitude of at least one of said space objects, referred to as target object, detected and identified by said long-range module, said short-range module being implemented when said long-range module has detected at least one space object located at a distance estimated to be less than a predetermined threshold distance,
a module for determining a possible rendezvous between at least said target object and the host satellite from an estimation of the trajectory of said target object and of said host satellite, and
a module for preparing and transmitting command instructions to said control unit of said means for moving and orienting said satellite based on said rendezvous determined by said rendezvous-determining module.

10. The navigation system as claimed in claim 9, further comprising an image-acquisition camera intended to provide images to the long-range processing module and an image-acquisition camera intended to provide images to the short-range processing module.
